(19) United States
(12) Patent Application Publication
(10) Pub. No.: US 2005/0237872 A1
(43) Pub. Date: Oct. 27, 2005

(54) MVC-003U method and system for multiple read/write heads for transferring date to/from a storage medium

(76) Inventors: Tan D. Nguyen, Palo Alto, CA (US); John Thomas, Palo Alto, CA (US); Mark L.D. Chappell, Los Altos, CA (US)

Correspondence Address: PILLSBURY WINTHROP SHAW PITTMAN LLP, P.O. BOX 10500, MCLEAN, VA, 22102, US

(21) Appl. No.: 10/979,999

(22) Filed: Nov. 2, 2004

Related U.S. Application Data
(60) Provisional application No. 60/521,413, filed on Apr. 21, 2004.

(51) Int. Cl. G11B 7/00

(52) U.S. Cl. 369/44.14

(57) ABSTRACT

A system and method are described for transfer of data between a memory location and a portable storage, such as an optical disk, at high efficiency data transfer rates. Such transfer rates allow for quick download of large data files containing multimedia data onto an optical storage medium, including handling multiple streams of data simultaneous, wherein the system is capable of adjusting to a failure in the component handling the transfer of the data onto the optical storage medium.

### CROSS-REFERENCE

This application is related to Provisional U.S. Patent Application Ser. No. 60/521,413, filed Apr. 21, 2004; entitled Multiple Read/Write Heads for Transferring Data To/From Optical Media, and 60/481,331 both of which are incorporated herein by reference.

### BACKGROUND OF THE INVENTION

1. Field of the Invention

The invention related to multimedia environment and more specifically to recording multimedia data onto a portable optical storage medium.

2. Background

Referring now to FIGS. 1 and 2, known Compact Mediums (CD) and Digital Video Medium (DVD) burners/players 10 contain one read/write head 12 per recording layer 14. Consequently, the read/write speed is limited to the fastest possible read/write speed of the head 12. For example, when recording data onto an optical storage medium 18, a shutter 20 defines an opening 21 therein. When the opening 21 of the shutter 20 is aligned with an opening 22 in a housing 24, then the recording layer 14 of the medium 18 is exposed. Once the recording layer 14 is exposed, the head 12 can begin recoding the data onto the recording layer 14 of the medium 18

In applications such as on-demand movie rentals and sales, where data on different tracks or segments can be formatted simultaneously and needs to be written quickly to minimize wait time, the current optical media burners/players with one read/write head per layer are inadequate; the problem is due to the fact that the head present a bottleneck.

Other applications such as simultaneous recording of multiple TV programs on a single optical medium are not possible due to the fact that a known optical recording devices can not process multiple streams of data simultaneously.

Additionally, if a read and/or write head of a current optical media burner/player fails, the unit becomes inoperable and there is no means to adjust and/or replace the number of read or write heads after purchase.

Therefore, what is needed is a system and method for transfer of multimedia data at efficient transfer rates in order to allow for quick download of large data files containing multimedia data onto an optical storage medium, including handling multiple streams of data simultaneously, wherein the system is capable of adjusting to a failure in the component handling the transfer of the data onto the optical storage medium.

### SUMMARY OF THE INVENTION

A system and method are described for transfer of multimedia data at efficient transfer rates in order to allow for quick download of large data files containing multimedia data onto an optical storage medium, including handling multiple streams of data simultaneous, wherein the system is capable of adjusting to a failure in the component handling the transfer of the data onto the optical storage medium.

The system includes a first head capable of receiving a first data stream and writing data to a first layer of the storage medium, a second head capable of receiving a second data stream and writing data to the first layer of the storage medium, control logic in communication with the first head and the second head, the control unit adapted to receive data from the memory location, to generate a stream of data in response thereto, and to partition that stream of data into the first and second data streams for substantially simultaneous transfer thereof from the first and second heads to the storage medium, respectively.

The method includes the steps of partitioning a data stream into a first component and a second component; storing the first and second components in first and second buffer, respectively; and transferring the first component of the data stream to the portable storage device using a first transfer means nearly simultaneous with transferring the second component of the data stream to the portable device using a second transfer means. The method also includes routing a first data stream to a first memory device, routing a second data stream to a second memory device, and transferring the data streams to the portable storage device using a first transfer means and a second transfer means, wherein the first and second transfer means operate independently to nearly simultaneously transfer the first and second data streams to the portable storage device.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 shows a block diagram representation of a prior art device for transfer of data onto the optical medium;

FIG. 2 shows a top view of the portable data storage medium;

FIG. 3 shows a block diagram representation of a system for transferring data onto a storage medium in accordance with the teaching of the present invention;

FIG. 4 shows a top view of a portable and/or an optical storage medium in accordance with the present invention;

FIG. 5 is a block diagram representation of the logical control for the motor speed of the system of FIG. 3 in accordance with the present invention;

FIG. 6 is a flowchart representation of a method for writing data to the optical medium when the system is operating in constant angular velocity (CAV) mode in accordance with the teaching of the present invention;

FIG. 7 is a flowchart representation of a method for writing data to the optical medium when the system is operating in constant linear velocity (CLV) mode in accordance with the teaching of the present invention;

FIG. 8 is a block diagram representation of data transfer to an optical storage medium with the data stream originating from a single source in accordance with the teaching of the present invention;

FIG. 9 is a block diagram representation of data transfer to an optical storage medium with the data stream originating from multiple sources in accordance with the teaching of the present invention;

FIG. 10 is flow chart for writing data onto the storage medium in accordance with the teaching of the present invention;

FIGS. 11a and 11b are block diagram representations of a load balancer used in conjunction with a partitioning unit in accordance with the teachings of the present invention; and

FIG. 12 is a flow for the process of writing onto a portable storage medium with a load balancer in accordance with the teaching of the present invention.

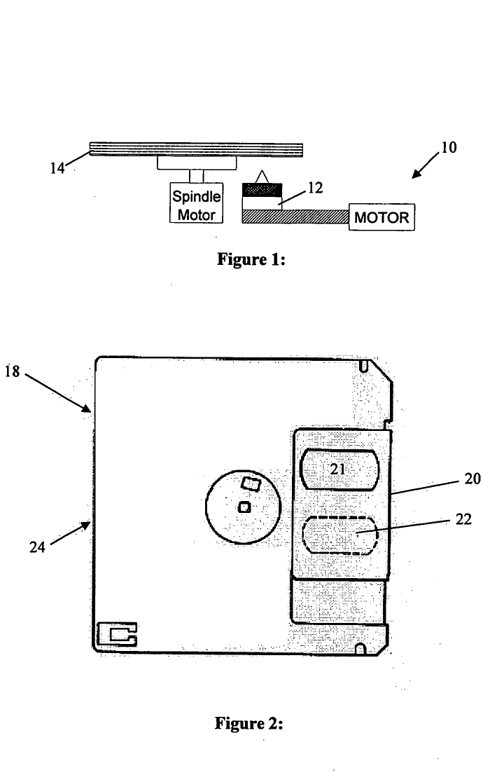

### DETAILED DESCRIPTION

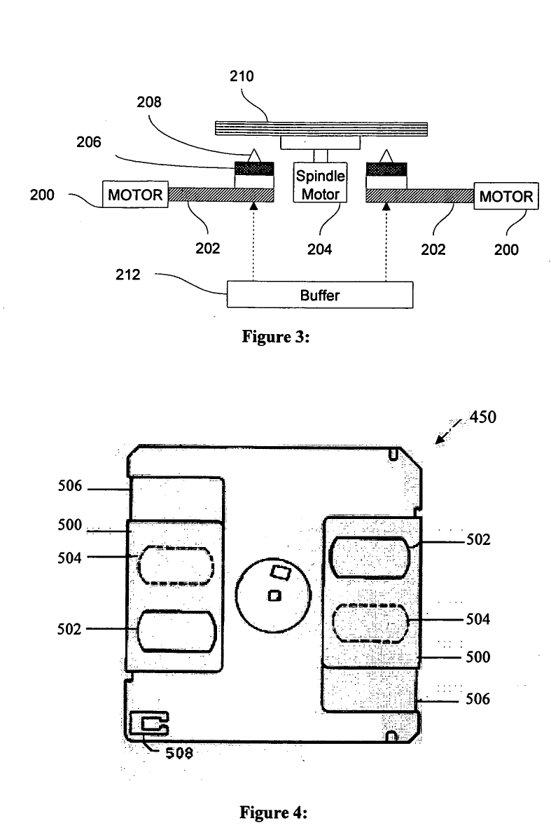

Referring now to FIG. 3, a system 150 includes motors 200 for moving the arms 202, a step or spindle motor 204, heads 206 that include laser diodes 208. The spindle motor 204 supports and moves or manipulates an optical data storage media or medium 210. The spindle motor 204 is also used to control the opening and closing of the drawer (not shown) for insertion of the medium 210. In alternative embodiments a separate motor may be used to control the drawer. The heads 206 are independently operable read and write heads with the ability to write on the same layer of the medium 210. The heads 206 are each secured to an arm 202 that is controlled by electronic signals delivered to the motor 200 that moves the head 206 to the location for the next write or read function. Buffers 212 are coupled to the heads 206 and are used to store data that is ready to be written to the medium 210.

In alternative embodiments, the heads 206 are write only heads and in yet another embodiment the heads 206 are a combination of read, write, and read/write heads depending on the relevant application as mentioned in detail below. For example, one head is a read head while at least one other head is a read/write head and at least one other head is a write-only head. Thus, within the scope of the present invention any combination of read, write-only, or read/write heads can be used. Furthermore, the present embodiment is discussed with respect to use of multiple heads to record data onto a portable storage medium, but is not limited thereto. For example, in an alternative embodiment the storage medium is a fixed data storage medium. In yet another embodiment, the heads are used for reading the data from the storage medium in the same manner that data is recorded onto the medium.

Each motor 200 is used to adjust the position of its respective head 206 relative to the medium 210. The heads 206 rely on the spindle motor 204 to spin the medium 210 and in the present embodiment operate concurrently according to control logic to provide accelerated and/or concurrent read/write operations in accordance with the optical medium industry standard specifications. The laser diode 208 could either be a single diode or multiple diodes, each burning to a different layer of the medium 210. Through use of optical actuator logic circuits, the movement of each of the heads 206 is controlled by an electromechanical unit that includes the motor 200 and the arm 202, which are driven by software, as discussed in detail below with respect to recording information onto an optical medium. In the present embodiment, the arm 202 includes a single head on multiple rails.

In an alternative embodiment, the system includes additional housings adapted to receive additional arm assemblies, which include a head and a laser diode as discussed in detail above. Furthermore, the each arm assembly is removable from the specific location and the drive housing will have slots for a certain number of modular read/write heads which may be removable heads.

There are various embodiments discussed herein and, hence, with most embodiments when the drive is powered up, the system runs through a “boot up sequence” logic that detects the existence of heads in the housing and runs a verification program to test if it is operational. Once the verification program is conducted, the system can determine how many of the heads are operational. If there are heads that fail the verification testing phase, then a warning is produced for every non-operational head/component in the housing. The warning is provided to the use and the user can either choose to continue or replace the arm assembly with a new arm assembly. If the user chooses to continue and does not replace the arm assembly that failed the verification testing, then the system will deactivate that arm assembly.

Referring again to FIG. 3, the mechanical arm 202 holds the head 206 using a pair of rails that allow the head 206 to be moved radially or near radially relative to the medium 210. There will be more than one actuator in the arm assembly. There will also be more than one set of rails and motors in the housing. With respect to each the arm assembly in the housing, each head slides along its own set of rails using its own motor.

Referring now to FIG. 4, a cassette medium or portable data storage medium 450 is shown. The medium 450 includes multiple independently operable shutters 500 defining an opening 502 therein. The housing of the medium 450 also defines multiple openings 504 therein corresponding to the number of opening 502 in the shutters 500. Each shutter 500 moves along the track 506 and thereby causes the opening 502 to be aligned with the opening 504 thereby exposing the media, such as medium 210. The positions of the openings relative to the medium 210 can vary depending on the application and the scope of the present invention is limited by the relative position of the aligned openings 502 and 504. The lock tab 508 can be used to prevent writing of data onto the medium 210.

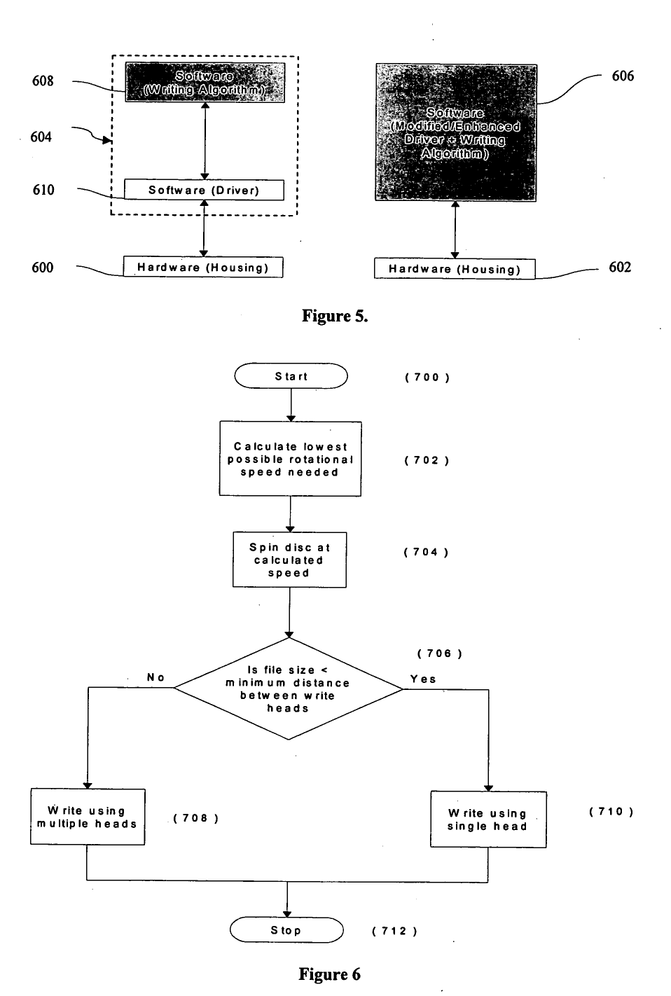

Referring now to FIG. 5, a standard motor in each housing 600 and 602 are shown coupled to control logic 604 and 606, respectively. The control logic 604 includes a writing control logic 608 and a driver logic 610. The control logic 604 and 606 are used for rotating the medium at a certain speed, which speed may be predefined based on system design or as predetermined by the standards body. As specified in FIG. 5, the motor can spin the medium at a desired speed either set by the driver logic and/or the feedback from the actuators. The control logic 604 could either be programmed (modified/enhanced) or controlled to make sure the medium or medium spins at a rate that keeps the actuators within the specified speeds depending on the predefined design parameters, such as Constant Linear Velocity (CLV) speed requirements or Constant Angular Velocity (CAV) operating speed ranges. Details about the CAV and CLV are described below. Control circuitry is used to control the movement of the optical head and driven by the algorithm or software used to control the circuitry.

As indicated above, when the system is powered up, it runs a startup sequence that sends signals to each of the heads in the housing. Each head sends an acknowledgment signal to the control circuit, indicating its presence. Each head that responds with an acknowledgement is presumed to be ‘active’ by the control circuitry and operational. Accordingly, the main controller can determine the number of operational heads relative to the total number of in the housing at start up.

Referring now to FIG. 6, the process of writing the file to the medium using CAV method begins at step 700. At step 702, the system calculates the lowest possible rotational speed so as to maintain the CLV of all operable heads [h1 . . . hN] within operable CLV specifications. Once this speed is determined, all the heads can write at the same time as long as they are reading/writing to ‘non-conflicting’ regions of the medium. At step 704, the system spins the medium at this calculated speed. The write head has a certain thickness/width/size and each head should be away from the other by a certain minimum distance. This defines the size of the smallest chunk of data that can be split and written by more than one head. For example, after examining the size of the write head, one can determine the minimum size of a file that can be written using multiple heads. At step 706, the size of the file to be written is compared to the minimum distance between the heads. If the size is smaller than this minimum distance, then at step 710 a single head will write that file. If the size of the file exceeds the minimum size, then at step 708 multiple heads will write the file.

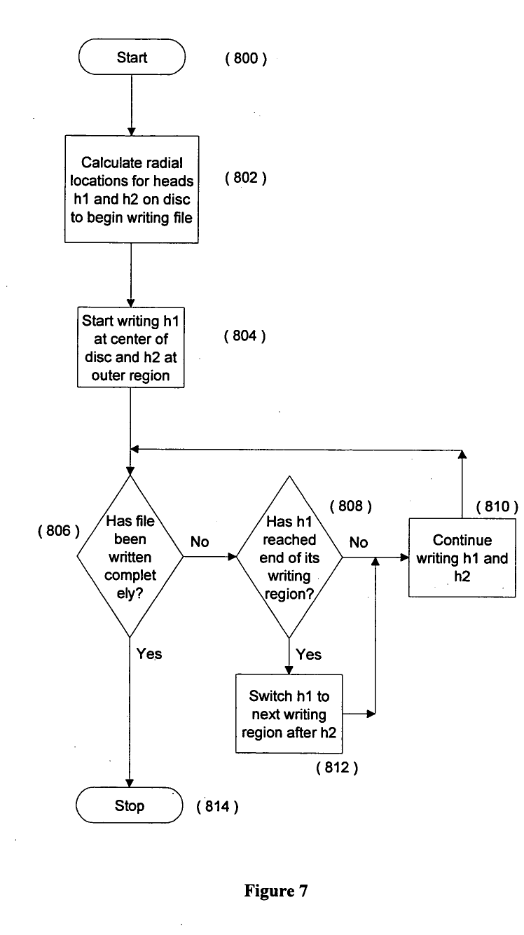

Referring now to FIG. 7, the process of writing the file to medium using CLV method begins at step 800. In the specific embodiment, there are two heads, h1 and h2. At step 802 the system calculates radial locations on the medium for h1 and h2. At step 804, the system starts writing using h1 and h2 at the pre-determined locations. For example, h1 at center of medium and h2 at the next region. The CLV is lowest for a given rotational speed, at the center. As h1 moves outward, the medium's rotational speed is reduced so as to maintain h1's CLV speed within standards specification. When h1 almost nears the start of h2 writing region, it would have almost reached the max of speed per the specification. At step 808, the system checks to see if h1 has reached the end of its writing region. At step 812, the system signals the motor of the arm assembly to move h1 over to the next writing region, which in the exemplary embodiment is further ahead of h2's writing region and towards outer edge of the medium. Rotational speed is adjusted to keep both h1 and h2 CLV within standards specification. At step 810, the system continues writing onto the medium with h1 and h2. The process continues until the complete file or data steam has been written and the process ends at step 814. This algorithm for processing a data stream and partitioning the data stream, as described below, can be extended for any number of heads; as long as the writing regions can be clearly defined on the medium for each of the heads, and medium rotational speeds are associated with each of the writing regions. Also the writing regions defined for the heads may not have a medium rate shifts in rotational speeds from one region to the next, but might have continuous shifts.

It is well known that every data storage medium is divided into a fixed number of ‘writable areas’ or sectors. These sectors can be pictured as blocks of data chained together, spiraling around the center of the medium. The medium also has a maximum capacity for data that can be written to it. Given the maximum size of the medium and the size of each sector, the number of sectors on the medium can be calculated. Similarly given any arbitrary size of data to be written to the medium, and the size of each sector, the number of sectors needed to write that chunk of data can be calculated. Using the number of sectors, the physical radial distance occupied by the chunk on the medium can be calculated.

In one embodiment referred to herein, the system includes a hardware recognition program that includes a software program representing an algorithm used to detect the addition/deletion of arm assemblies or actuators to/from the housing, respectively. When a new head is added to the housing and the drive is started up, the hardware recognition program is executed. The program sends a signal to each of the arms in the housing and waits for a response. A simple binary signal can be used to detect the existence of an optical head in the arm. For example, 1 is used if the arm assembly exists and a 0 is used if it does not exist. In addition to verification of the presence of an arm assembly, the program also verifies that the arm assembly functions properly as set forth herein. The program generates a count of the number of functioning heads and stores the value in memory. Thus, a total number of functioning arm assemblies are identified and the value is used by the data-writing unit when data needs to be written to the medium.

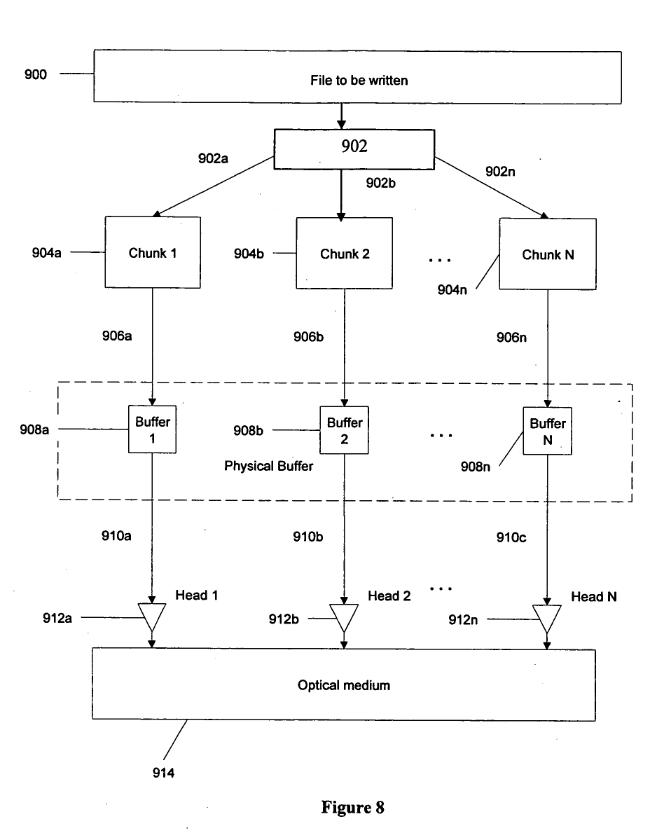

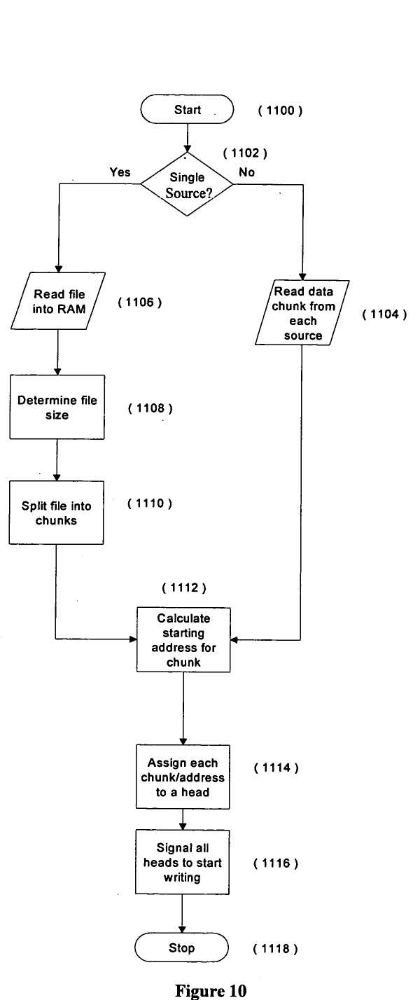

Referring now to FIGS. 8 and 10, the algorithm for the data-writing component begins at step 1100. At step 1102 it is determined if a single stream of data or multiple streams of data need to be transferred by the system to a storage medium. If there is only one data stream, then at step 1106, a file 900 that is to be written into memory (RAM) is read. At step 1108, the system determines the size of the file 900 to be written, which can be either a complete file or a portion of the file. At step 1110, control logic 902 splits the data stream into a plurality of chunks 904a, 904b . . . 904n of equal size corresponding to the number of heads in the system. It will be apparent to one skilled in the art the control logic 902 can be implemented using software, hardware, or a combination of hardware and software. Furthermore, the control logic 902 may be a part of the system or it may be remotely located relative to the system in either a memory location that is part of a remote device or on a portable storage device, such as a magnetic disk or an optical disk. At step 1112, the system calculates the starting address for each chunk of data on the medium. For example, if the file to be written is split into 2 chunks, each chunk being 32 KB, then the first chunk should start at Logical Block Address corresponding to address# 0, and the second chunk should start at address# 6384, which represents the proper separation measured in multiples of 2 KB—as per current optical DVD+RW specifications.

At step 1114, the system assigns each chunk of data along with its starting address to each corresponding head 912a, 912b . . . 912n and stores the corresponding chunk in the corresponding buffer 908a, 908b . . . 908n. This mapping can be specified in a simple data structure like a hash table. The data chunks are read into device buffers 908a, 908b . . . 908n. At step 1116, the system signals all of the heads 912a, 912b . . . 912n to read the data chunks from their respective device buffers 908a, 908b 908n and simultaneously write the assigned chunks at the specified addresses on the same layer 914 of the medium.

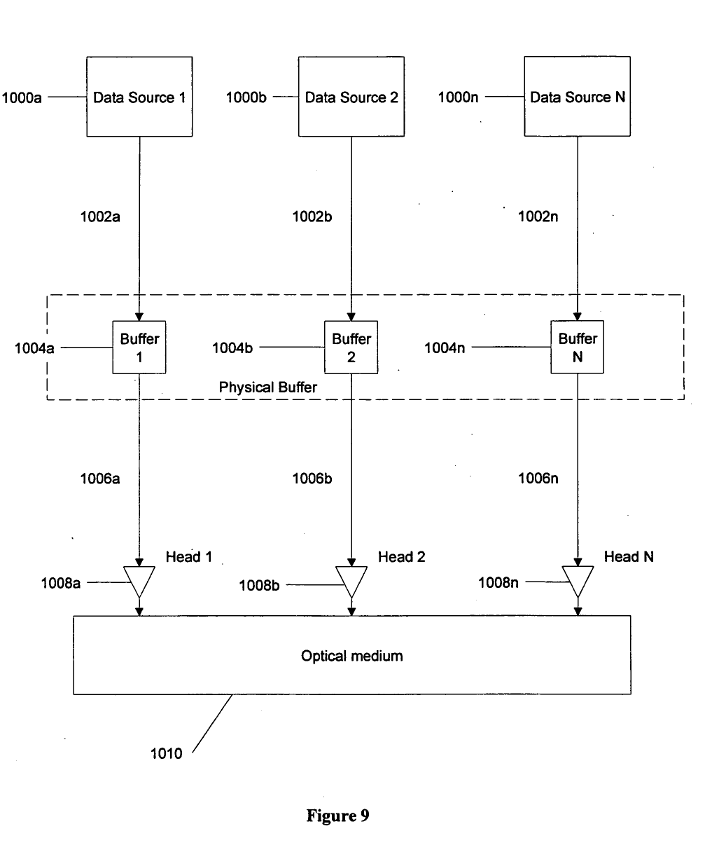

Referring now to FIGS. 9 and 10, the algorithm for the data-writing component can also be used to write multiple chunks of data from multiple streams from multiple sources. The process begins at step 1100 with data streams from multiple sources. If at step 1102 it is determined that data streams are coming from multiple sources, then at step 1104, the system reads from the data sources 1000a, 1000b . . . 1000n and stores the data into the buffers 1004a, 1004b . . . 1004n. For example, the multiple data sources could be from multiple TV tuner channels.

The size of the data written by each head 1008a, 1008b . . . 1008n to the same layer 1010 of the medium in this algorithm is determined by the maximum size of the buffers 1004a, 1004b . . . 1004n. For example, if the buffer size is 128 KB and a TV channel does not output data of size 128 KB, that channel is written to medium when the buffer is full or the channel has ended. In alternative embodiments, the system writes the data in the buffers even though the size of the data in the buffer is less than 128 KB.

At step 1112, the system calculates the starting address for each chunk of data (in the buffers) on the medium (as per Step# 4 in the previous algorithm). At step 1114 onwards, the system continues, as indicated above, with the partitioning of the data to the heads. The buffers for each head mentioned in this algorithm could be virtual buffers within one or many physical buffers that are specifically assigned.

The embodiments set forth herein include the ability to add identification information to the file or data stream for the purpose of tracking the origin of the data stored on the medium. For example, if the data is a movie that is being downloaded onto the storage medium, then information that identifies the person that bought the storage medium can be embedded into the data stream or file that is being stored as set forth in U.S. patent application Ser. No. 10/949,542 entitled Method and Apparatus for On-Demand Multimedia Rental and Sales filed on Sep. 23, 2004.

In various embodiments, the data writing component algorithm mentioned above is replaced with a Load Balancing unit that uses a specific algorithm to assign chunks of data to the heads and signals them to begin writing.

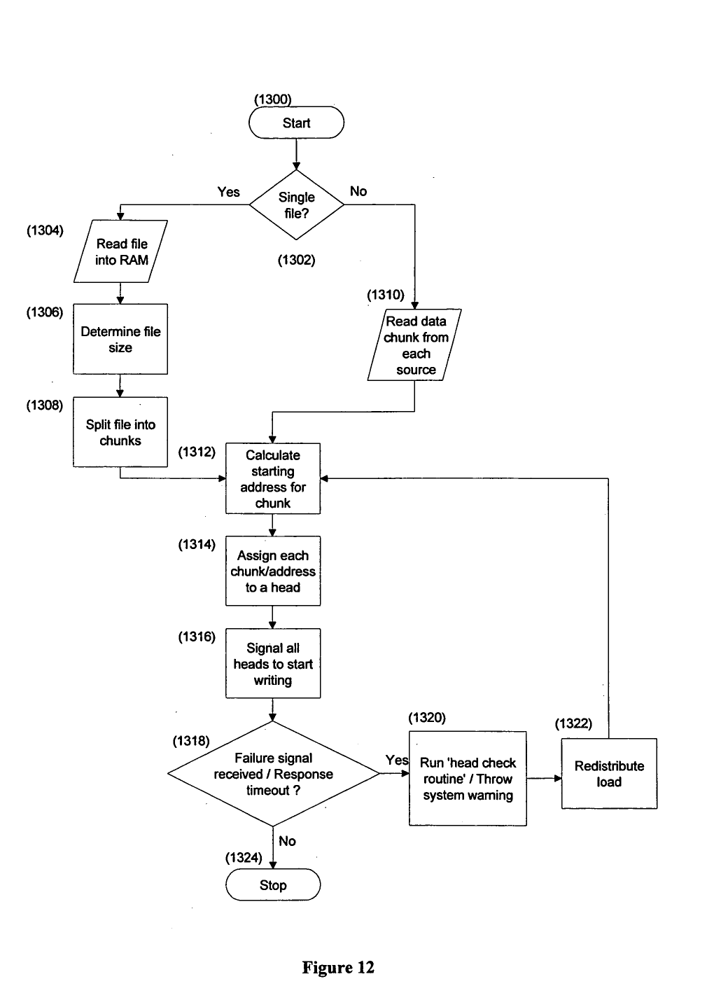

Referring now to FIG. 12, the process of load balancing begins at step 1300. At step 1302 it is determined if a single stream of data or multiple streams of data need to be transferred by the system to a storage medium. If there is only one data stream, then at step 1306, the file that is to be written into memory (RAM) is read. At step 1308, the system determines the size of the file to be written, which can be either a complete file or a portion of the file. At step 1310, a control unit splits the data stream into a plurality of chunks of equal size corresponding to the number of heads in the system.

At step 1312, the system calculates the starting address for each chunk of data on the medium, as indicated above. At step 1314, the system assigns each chunk of data along with its starting address to each corresponding head 1206a, 1206b . . . 1206n and stores the corresponding chunk in the corresponding buffer. This mapping can be specified in a simple data structure like a hash table. The data chunks are read into device buffers. At step 1316, the system signals all of the heads 1206a, 1206b . . . 1206n to read the data chunks from their respective device buffers and simultaneously write the assigned chunks at the specified addresses on the same layer of the medium 1208.

After each head has written the assigned chunk of data to medium, it sends a feedback signal to the main driver to indicate success or failure. At step 1318 the system determines if there was a failure. If either a failure signal is reported or the expected completion time of the head has passed and no signal is received from the head, then a Load Balancer unit 1200 assumes that the head, which did not sent a success signal or sent a failure signal, is non-functional. At step 1320, the Load Balancer turns on a “head check” routine for the faulty head offline, and initiates or throws a system warning indicating that head needs to be replaced.

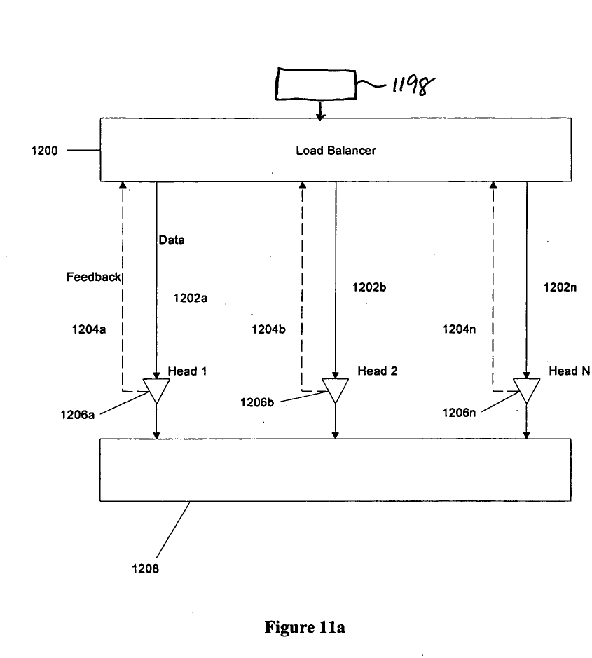

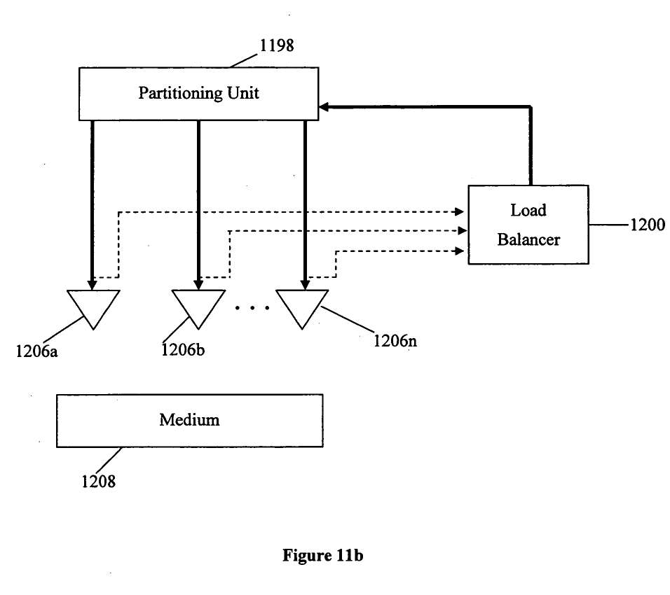

Referring now to FIGS. 11a and 12, a partitioning unit 1198 partitions the data stream into a plurality of data chunks that are sent to a load balancer 1200. At step 1322 the load balancer 1200 redistributes the ‘load’ or the chunks of data, which were to be written by the failed head, to be written by the remaining heads. For example, if there are 4 heads in the housing and 4 chunks of data assigned to them, and one head fails, the Load Balancer 1200 redistributes the chunks of data across 3 heads instead of 4.

Referring now to FIGS. 11b and 12, in an alternative embodiment, the load balancer 1200 monitors each of the heads 1206 to ensure that the heads 1206 are operational. If a head 1206 fails, then the load balancer signals the partitioning unit 1198 to route the data chunk streams from the failed head to the other heads.

The above embodiments may be altered in many ways without departing from the scope of the invention. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

1. Apparatus for managing the transfer of data between a memory location and a storage medium comprising:
a first head capable of receiving a first data stream and writing data to a first layer of the storage medium;
a second head capable of receiving a second data stream and writing data to the first layer of the storage medium; and
a control logic in communication with the first head and the second head, the control logic adapted to receive data from the memory location, to generate a stream of data in response thereto, and to partition that stream of data into the first and second data streams for substantially simultaneous transfer thereof from the first and second heads to the storage medium, respectively.

2. The apparatus of claim 1 further comprising:
a first buffer in communication with the first head;
a second buffer in communication with the second head, wherein the first and second buffers store the first and second data streams, respectively, for near simultaneous transfer by the respective heads.

3. The apparatus of claim 2 further comprising a load balancer unit in communication with the control logic for monitoring the status of each head and signaling the control logic to route the next partitioned data to the appropriate head.

4. The apparatus of claim 1 further comprising a test unit coupled to and in communication with the control logic for initiating a verification process in order to determine which head is operational.

5. The apparatus of claim 4 further comprising at least one housing adapted to receive a third head, wherein the housing is in communication with the control logic and the test unit.

6. The apparatus of claim 1 wherein the storage medium is a portable DVD and wherein the first head is adapted to transfer data to a first layer of the DVD and the second head is adapted to transfer data to the second layer of the DVD.

7. The apparatus of claim 1 wherein the first portion is transferred onto a location on the layer of the portable storage and the second portion is transferred onto another location on the same layer of the portable storage.

8. The apparatus of claim 1 comprising a load balancer unit in communication with the control logic for monitoring the function of each of the heads to determine if a head has failed and signaling the control logic to re-routing the partitioned data from the failed head to another head.

9. A method for high speed data transfer to an optical storage device, the method comprising the steps of:
partitioning a data stream into a first component and a second component;
storing the first and second components in first and second memory locations, respectively; and
transferring the first component of the data stream to the optical storage device using a first transfer unit nearly simultaneous with transferring the second component of the data stream to the optical storage device using a second transfer unit.

10. The method of claim 9 further comprising the steps of:
monitoring each transfer unit in order to detect the status of each transfer unit; and
in response to an alarm condition relating to the condition of one transfer unit, re-routing the respective component of the data stream to another transfer unit.

11. The method of claim 9, wherein the step of transferring includes controlling the relative position of each transfer unit relative to the optical storage device to prevent the first and second transfer unit from over-writing to the same location on the optical storage device.

12. The method of claim 9, wherein the first transfer unit is adapted to transfer data onto a first layer of the optical storage device and the second transfer unit is adapted to transfer data onto the first layer of the portable storage device.

13. A method for near simultaneous transfer of multiple streams of data to a portable storage, the method comprising the steps of:
routing a first data stream to a first memory location;
routing a second data stream to a second memory location; and
transferring the data streams to the portable storage using a first transfer unit and a second transfer unit, wherein the first and second transfer unit operate independently to nearly simultaneously transfer the first and second data streams to the portable storage.

14. A system for near simultaneous transfer of a first stream of data and a second stream of data from a first external source and a second external source, respectively, to a portable storage medium, wherein the system is adapted to be coupled to the first and second external sources, the system comprising:
a first means adapted for transferring the first data stream to the medium;
a second means adapted for transferring the second data stream to the medium; and
a control means in communication with the first and second transfer means for managing and routing the first data stream and the second data stream to the respective transfer means and for and monitoring each of the transfer means.

15. The system of claim 14 wherein the control means comprises:
a balancing means for generating a control signal in response to detection of failure in at least one of the first and second transfer means; and
a partitioning means in communication with the balancing means for preparing the data streams for transfer to respective buffers for the first and second transfer means, wherein the partitioning means is responsive to the balancing means detection of one failed transfer means to route data to the functioning transfer means.

16. The system of method of claim 15, wherein the partitioning means comprises:
a first means for partitioning the first data stream into a plurality of components;
a second means for partitioning the second data stream into a plurality of components; and
a routing means in communication with the first partitioning means and the second partitioning means for routing the plurality of components of the first and second data stream based on the control signal from the balancing means.

17. The system of claim 14 wherein the control means comprises:
a partitioning means for partitioning and preparing each of the data streams for transfer to the storage medium; and
a load balancing means in communication with the partitioning means for receiving the prepared data streams for transfer to the storage medium, wherein the load balancing means monitors the function of each of the transfer means and in response to a failure of any transfer means routes the data stream to another transfer means.

18. The system of claim 14, wherein the control means comprises:
a first partitioning means for partitioning the first data stream;
a second partitioning means for partitioning the second data stream;
a routing means in communication with the first and second partitioning means for routing the data streams to the first and second transfer means based on feedback from each of the transfer means.

19. An apparatus for transferring data between a memory location and a storage medium comprising:
a first head capable of receiving a first data stream and writing data to a first layer of the storage medium;
a housing adapted to receive a second head, wherein the housing is capable of receiving a second data stream that is to be written to the first layer of the storage medium; and
a control logic in communication with the first head and the housing, the control unit adapted to receive data from the memory location, wherein the control logic partitions the stream of data into the first and second data streams for substantially simultaneous transfer to the storage medium.
